(19) United States
(12) Patent Application Publication
(10) Pub. No.: US 2013/0204574 A1
(43) Pub. Date: Aug. 8, 2013

(54) Method for Estimating Positions Using Absolute Encoders

(71) Applicants: Amit Agrawal, Somerville, MA (US); Jay Thornton, Watertown, MA (US)

(72) Inventors: Amit Agrawal, Somerville, MA (US); Jay Thornton, Watertown, MA (US)

(21) Appl. No.: 13/367,549

(22) Filed: Feb. 7, 2012

(51) Int. Cl. G06F 15/00

(52) U.S. Cl. 702/150

(57) ABSTRACT

A position is determined by sensing a signal corresponding to a subsequence of marks in a non-periodic sequence of the marks on a scale. A coarse position P_{A} is determined by matching the subsequence with all possible subsequences of the non-periodic sequence. Zero-crossings corresponding to rising edges of the signal and zero-crossings corresponding to falling edges of the signal are detected. An incremental position Pᵢ is determined using the zero-crossings. The coarse and the incremental position are summed to obtain the position.

### RELATED APPLICATION

This application is related to U.S. application Ser. No. 13/100,092, “System and Method for Measuring Positions,” filed by Veeraraghavan et al. on May 3, 2011, and incorporated herein by reference.

### FIELD OF THE INVENTION

The invention generally relates to position measurement devices, and in particular to measuring positions with absolute encoders.

### BACKGROUND OF THE INVENTION

Position estimation is an important task in industrial automation, and similar applications. Devices, such as numerically controlled (CNC) machines, drill bits, robot arms or laser cutters, and assembly lines need position measurements. Feedback control is often used for precision position measurements. It is desired to determine positions at high sampling rates to enable accurate feedback control.

Optical encoders are typically used to measure incremental or relative positions. A scale having regularly spaced marks is used along with a readhead including sensors to estimate the relative position between the marks. Incremental linear encodes can only measure the relative position within a period of the scale. A relative position encoder senses a number of scale periods traversed to determine the absolute position.

An absolute position encoder can determine the absolute position directly. Absolute position encoders are preferred because they do not require a memory and power to store the current position. In addition, absolute encoders provide absolute position at start up, while relative position encoders typically need to locate a beginning point to determine a current position at start-up, which takes time and may not be possible for some applications.

Several linear encoders are known. In a simplest form, a relative linear encoder can measure linear position by optically detecting the marks on the scale fixed parallel to the readhead. However, the resolution of the relative position is limited by the resolution of the marks on the scale. For example, a scale with a resolution of 40 microns, cannot obtains a resolution of 0.5 microns.

In a conventional absolute encoder, a unique pattern of marks, representing codes of one and zero bits, is used for each position. With one scale, a position change is determined when the bit pattern in the sensed code changes. In this case, the resolution of the position estimate is the same as that of the pattern on the scale, and may be insufficient.

To improve resolution, one method uses multiple scales aligned in the detection direction with periodic scale patterns including opaque and transparent marks. The scales are illuminated from one side and a photodiode senses the light that passes through the scales to the other side. As the scales moves relative to each other and the read head, the signal on the photodiode varies between a maximum value and a minimum value. A demodulation procedure can then determine the phase θ of the signal, which is transformed into the relative position estimate. The relative position can be recovered at a higher resolution than the scale resolution. In some encoders, one of the scales can be replaced by a grating inside the readhead.

However, such encoders only provide relative position. For absolute positioning, linear encoders need additional scales, which increases the cost of the system. Such hybrid encoders infer incremental and absolute position using separate scales. In such designs, yawing of the readhead can result in errors. In addition, such encoders need two readheads, one for sensing incremental positions, and another for sensing absolute positions.

A small number of photodiodes in the readhead of linear encoders need precise radiometric calibration of the sensed signal. Often, non-linearity in the signals results in a bias, and sub-divisional ripple errors during the phase estimation.

One absolute linear encoder uses one scale, and a single readhead. It has two separate mechanisms for reading incremental and absolute positions. The incremental positions are obtained using a filtering readhead technique, which utilizes a grating inside the readhead for generating fringes that are sensed in a photodiode array. The absolute positions are sensed using a different mechanism, which uses an imaging lens and a detector, i.e., a linear image sensor.

To reduce the cost of an absolute linear encoder, some systems use only one scale and only one readhead with a single sensing mechanism. One such system is described in the related application. That system avoids two sensing mechanisms for reading incremental and absolute position. For a real-time implementation, a fast procedure is required to decode the position from the sensed data. The related application describes a system and method for measuring positions that use a procedure based on a correlation of the sensed signal with a reference signal generated using an underlying absolute code. That requires generation of the reference signal for every position. However, correlation based procedures are slow, and cannotachieve rates of several KHz with off-the-shelf low cost digital signal processors (DSPs).

Some procedures interpolate the sine or cosine signals from a relative optical encoder into a high-resolution position signal. However, those procedures only work on sine or cosine signal based relative encoders, and cannot be applied directly to absolute encoders, where the sensed signal is non-periodic.

Special designed hardware such as field programmable gate arrays (FPGA) and application specific integrated circuits (ASICs) can be used to determine the position information from the sensed signal, however, at an increased cost.

It is desirable to only use off-the-shelf DSPs. Therefore, a method that can yield high precision position information at high speed, and can be implemented on off-the-shelf digital DSPs is required.

### SUMMARY OF THE INVENTION

The embodiments of the invention provide a method for determining high precision position estimates for absolute single track encoders. The high precision of the method achieves absolute accuracy within a micron. The high speed of the method achieves rates of several KHz using a conventional digital signal processor (DSP).

### BRIEF DESCRIPTION OF THE DRAWING

FIG. 1 is a schematic of a scale according to embodiments of the invention;

FIG. 2 is a schematic of a sensed signal and a code using the scale of FIG. 1;

FIG. 3 is a schematic of decoding a bit sequence to obtain a position according to embodiments of the invention;

FIGS. 4A-4B show ideal relative and absolute waveforms;

FIG. 5 is a schematic of a zero-crossing point detected according to embodiments of the invention;

FIG. 6 is a schematic of the number of bits between every two zero-crossings; and

FIGS. 7-8 are schematics respectively for fitting lines to rising and falling edges of the waveform according to embodiments of the invention.

### DETAILED DESCRIPTION OF THE PREFERRED EMBODIMENTS

The embodiments of our invention provide a method for determining high precision position estimates for absolute single track linear encoders.

Absolute Scale

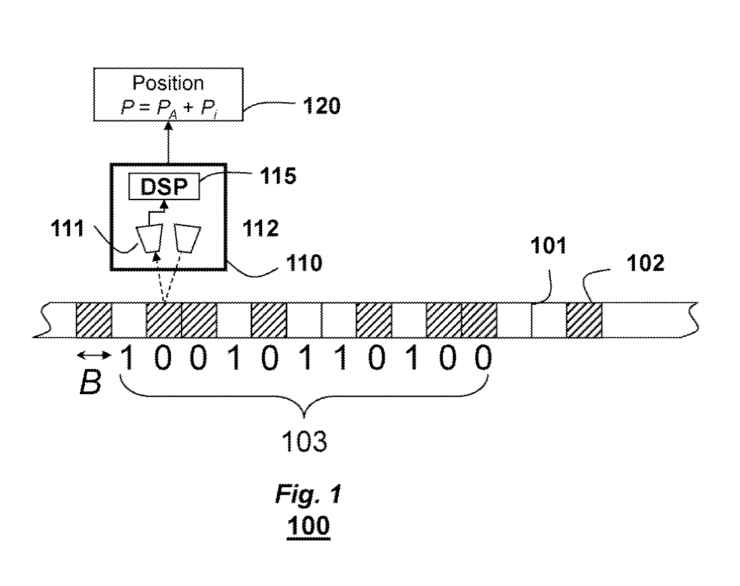

FIG. 1 shows a scale 100 of an absolute encoder for one embodiment of our invention. Details of the scale are described in the related U.S. application Ser. No. 13/100,092, incorporated herein by reference. The scale is used to determine a high-resolution position P=P_{A}+Pᵢ 120.

The scale can include alternate light reflecting 101, and non-reflecting 102 marks. Each mark is B microns wide, which the scale resolution.

The width B of each mark is a half-pitch. In one embodiment, B is 20 microns. A readhead 110 is mounted at some distance and parallel to the scale. The readhead includes a sensor 111, a (LED) light source 112, and an optional lens. The sensor can be a detector array of N sensors, e.g., N is 2048. The array can be complementary metal-oxide-semiconductor (CMOS) or charge coupled device (CCD). The readhead also includes a conventional digital signal processor 115 connected to sensor.

The marks can also alternate between opaque and transparent, depending on a relative position of the light source with respect to the readhead.

To achiever 100% information density on the scale, a bit sequence is used. Every subsequence has a finite length and is unique, e.g., a de Bruijn sequences 103. A k-ary de Bruijn sequence B(k, n) of order n is a cyclic sequence of a given alphabet with size k, for which every possible subsequence of length n in the alphabet appears as a sequence of consecutive characters exactly once. If each B(k, n) has a length kⁿ, then there are (k!^{k(n-1)}))/kⁿ distinct De Bruijn sequences B(k, n). When the sequence is truncated from front or back, the resulting sequence also has the uniqueness property with the same n.

For a scale with a one meter length with half-pitch B=20 microns, a 50000 bit long sequence is required. A longer sequence of length 2¹⁶=65536 with an order of 16 can also be used. This sequence can be truncated from the front or back to obtain a 50000 bit sequence. It should be noted that any non-periodic sequence with non-repeating subsequences can be used.

The detector array requires a field of view (FOV) of at least n bits for decoding to be possible. For the half-pitch B=20 microns and using the de Bruijn sequence of order 16 requires that the FOV is 16×20=320 microns on the scale. In one embodiment, the field of view is designed to be 1-2 mm to have the desired accuracy.

For Nyquist sampling, each bit of the sequence, i.e., each half-pitch of the scale, maps to at least two pixels in the linear detector array. This requires at least 16×2=32 pixels, which is well-below the number of pixels in conventional sensors. To handle optical aberrations, such as defocus blur, the number of pixels per half-pitch can be increased.

The marks on the example scale are arranged linearly. Other configurations of the marks on the scale are also possible, for example circular, oval, serpentine, and the like. The only requirement is that the marks are arranged sequentially for a particular code or non-periodic sequence.

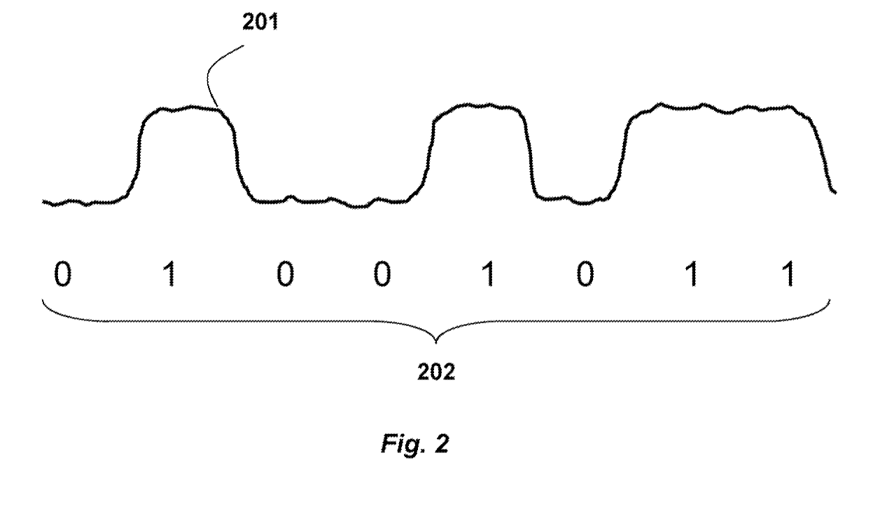

FIG. 2 shows a sensed signal 201, up to one bit (half-pitch), and a corresponding decoded sequence 202. A look-up table of length 2ⁿ can be used to determine the position decoded sequence within the entire de Bruijn sequence.

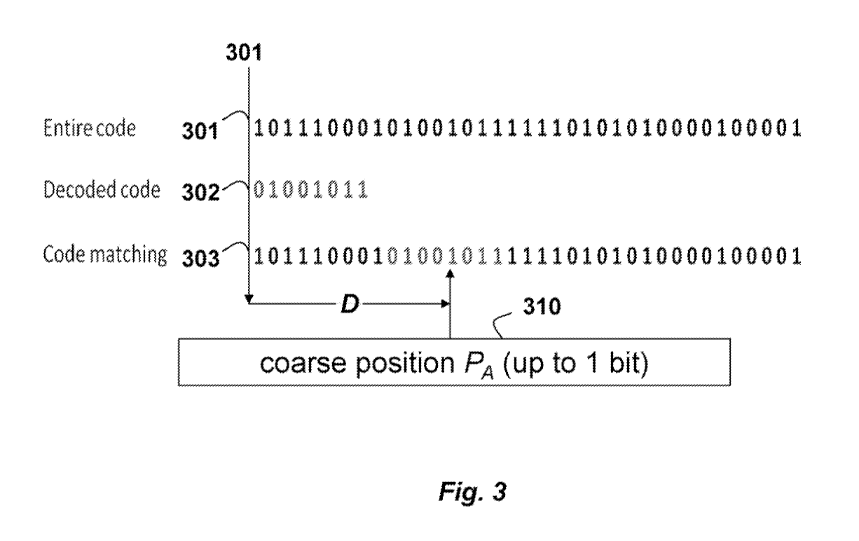

FIG. 3 shows a de Bruijn sequence 301, a decode sequence, a result of code matching with a look-up table, and a coarse position P_{A} 310 corresponding to one bit in the sequence. The look-up table stores all possible subsequences of the non-periodic sequence, and their distance P_{A} from the start 300 of the scale.

To handle bit errors, encoding schemes, such as Manchester encoding, can be applied to the de Bruijn sequence. This doubles the required bits for decoding. In other embodiment, the de Bruijn sequence can be designed to enable fast position decoding with a smaller look-up table.

In some applications, the recovered resolution of the position should be substantially higher than the half pitch scale resolution B. For example, the accuracy requirement could be 0.5 micron, 40 times smaller than B (20 microns). Thus, we require a super-resolution method that can resolve the position within each mark on the scale. This is referred to as high precision (fine) positioning.

It is important that the high precision positioning can work with any scale pattern, such as the absolute scale. This enables the encoder to be useful in variety of applications.

Method Description

Given a 1D sensor with N pixels, a 1D representative signal of the scale is acquired. The length of a block of pixels corresponding to each black or white mark on the scale is F, where F depends, optionally, on a lens magnification. The frequency or pixels per half-pitch is F.

Ideally, the intensity (amplitude) of the reflecting (or transparent) region of scale is large, e.g. 200 for a gray scale of 255 levels for an 8 pixel sensor, and the intensity of the non-reflecting region of the scale is be small, e.g. zero on the gray scale.

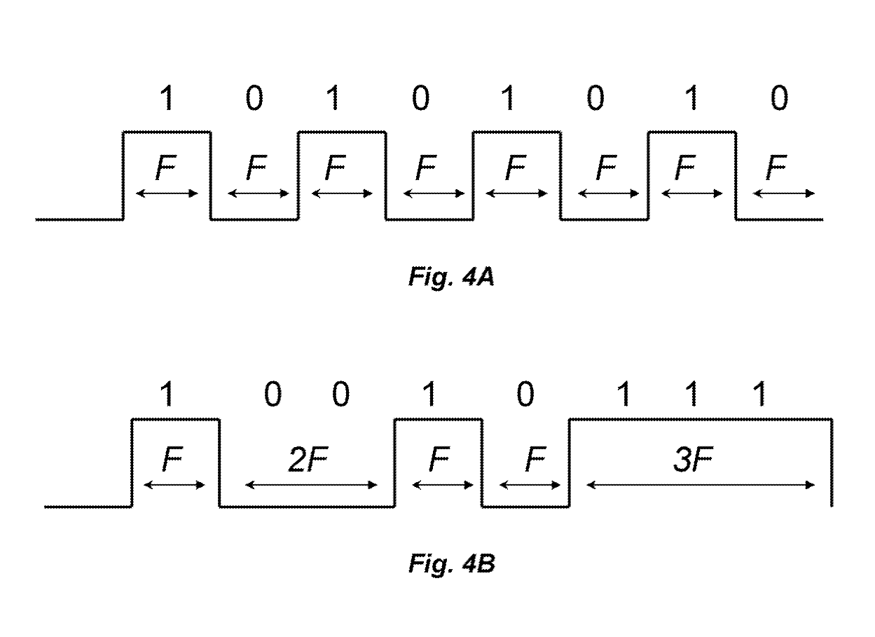

As shown ideally in FIG. 4A, the signal of a relative scale corresponds to a square waveform at the sensor is high for F pixels, and then low for F pixels, etc.

As shown in FIG. 4B for the absolute scale, the sensed signal is high for some integer multiple of F, low for some integer multiple of F, and so on as. The integer multiple depends on the underlying absolute code, or is always one for the relative scale.

In practice, several factors result in deviation of the scale image. These include but are not limited to:
(a) random noise of the sensor;
(b) gamma and other non-linearities;
(c) fixed-pattern noise of the sensor;
(d) optical defocus;
(e) relative angular errors of scale positioning with respect to the sensor;
(f) scale magnification due to heat; and
(g) motion blur due to relative motion between the scale and the sensor.
(h) optical distortions due to lens

For accurate positioning, it is important that the method is resilient to these factors.

One known method for positioning estimation using an incremental scale is based on estimating a phase θ of the signal using a demodulation technique, e.g., an arctangent method. The sensed signal is multiplied by a sine wave and a cosine wave of the same frequency. The result is low pass filtered and averaged. Then, the arctangent of the ratio of two values is used to determine the phase of the sensed signal. The phase can be converted to the position using the scale resolution B according to

$$P = \frac{θ \times B}{π} .$$

However, that method works only on an incremental (periodic) scale, and cannot be applied to an absolute scale using a non-periodic sequence. The non-periodic sequence modifies the phase, and introduces signals at additional frequencies compared to the periodic sequence. This causes errors.

Thus, a high precision positioning method that can be used for absolute scales with non-periodic Bruijn sequences is required.

Phase Definition for Absolute Scale

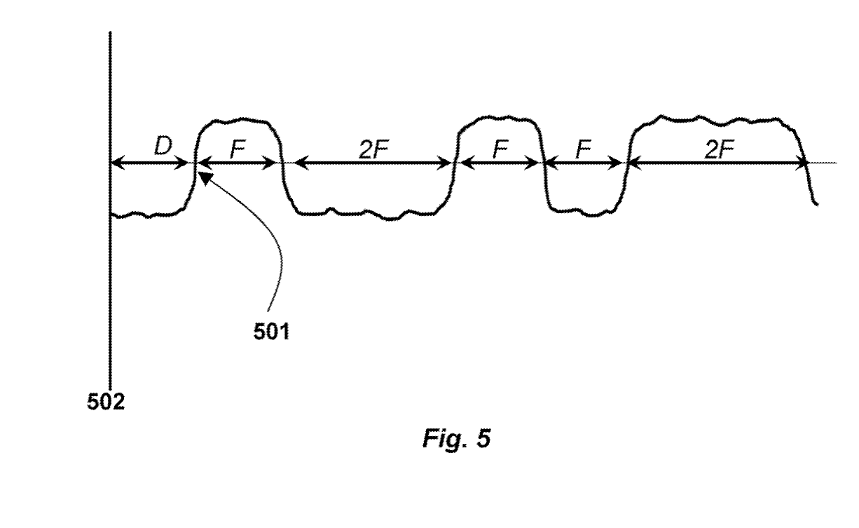

For absolute scales, the phase can be defined using a reference zero-crossing distance D 501 of the signal with respect to the start of the signal 502, as shown in FIG. 5. The incremental phase

$$θ = \frac{D π}{F} ,$$

and the incremental position Pᵢ is

$${P}_{i} = \frac{θ B}{π} = \frac{DB}{F} .$$

The coarse position P_{A} is obtained by matching the underlying code sequence with the known non-periodic sequence. The coarse position can be obtained using a pre-determined look-up table. The final absolute position P is the sum of the coarse position P_{A} and the incremental position Pᵢ, P=(P_{A}+Pᵢ).

To estimate the absolute position, we estimate D, F and the underlying sequence from the sensed 1D signal S.

Detection of Zero-Crossings

A threshold m can be subtracted from S and the zero-crossings of the resulting signal correspond to the edges in the original scale. The threshold can be pre-determined, e.g., for 128 of the gray level, or estimated from sensed signal S, e.g., an average gray value of S. The threshold can be fixed, or refined along with phase and frequency. The signal can be filtered before detection of zero-crossings to reduce the effect of noise as in conventional edge-detection techniques.

First, we describe the general case, where m is obtained from the signal S and is refined to a higher resolution along with D and F.

The initial value of in is estimated from the signal S. Because the gain of the signal S is unknown, the pre-determined value, such as 128, is incorrect. Therefore, the initial value of m is selected to be an average intensity (amplitude) of the signal S

$$m = \frac{{\sum }_{p = 1}^{N} S ( p )}{N} ,$$

where N is the number of samples of the signal S.

Detection of Rising Edges

Pixel intensities are determined such that the signal value S is less than m for the current pixel, and greater than m for the next pixel. Let p be such a pixel such that

S(p)<m, and S(p+1)>m.

Then, the pixels p correspond to the rising edges of the signal.

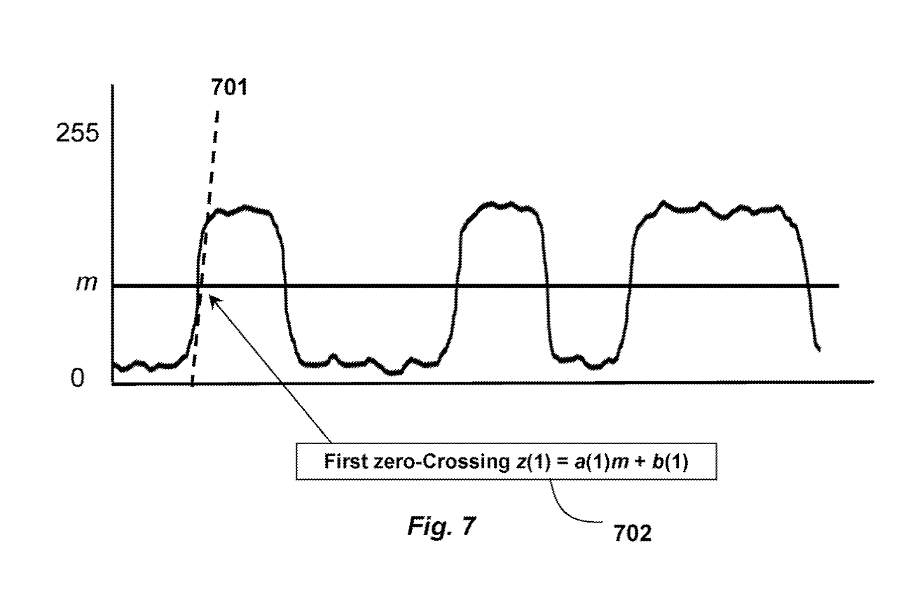

As shown in FIG. 7, a line 701 is fitted to a rising edge, and a slope a and intercept b of the line are determined. The first zero-crossing z 702 is the spatial location corresponding to the intensity of m on the line is

z=a×m+b.

The slope a and intercept b are

$$a = \frac{1}{S ( p + 1 ) - S ( p )} , b = p - \frac{S ( p )}{S ( p + 1 ) - S ( p )} ,$$

respectively, z is determined at sub-pixel resolution using the above equation.

Detection of Falling Edges

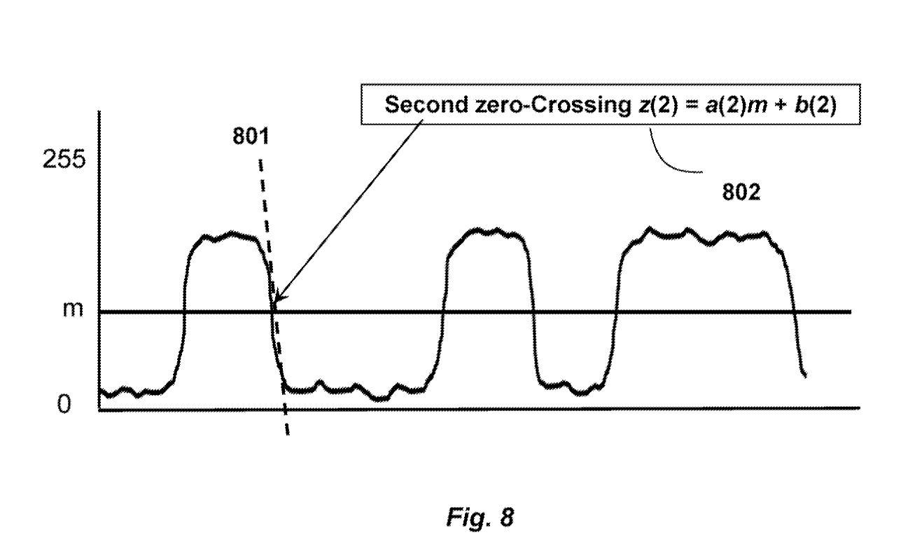

As shown in FIG. 8, zero crossings are determined for the falling edges by locating pixels such that the signal value is greater than m for current pixel and less than m for the next pixel. Let p be a pixel such that

S(p)>m, and S(p+1)<m.

The pixels p corresponds to the falling edges of the signal.

Using the two pixel values S(p) and S(p+1), a line 801 is fitted to the falling edge, and the slope a and intercept b of the line is determined. The zero-crossing z 802 is the spatial location corresponding to the intensity value of m on the line

z=a×m+b.

The slope a and intercept b for falling edges are the same as above.

If there are K zero-crossings, then z(i) denote the i^{th} zero-crossing. Similarly, a(i) and b(i) denote the slope and intercept for the i^{th} zero-crossing

z(i)=a(i)×m+b(i), for i=1 to K.

Let dz(i)=z(i+1)−z(i), for i=1 to K-1, be the difference of subsequent zero-crossings. Using the difference of zero-crossings, a coarse value of F is given by the minimum of dz(i). Similarly, a coarse value of D is obtained as the first zero-crossing first zero-crossing D=z(1)=a(1)m+b(1).

Joint Refinement of D, F and m

After estimating coarse values of D and F, information from all zero-crossings are used to refine the coarse values to a higher resolution.

The phase θ is dependent on the location of the first zero-crossing D. A joint estimation of D, F and m is performed to refine the value of these variables. This estimation uses the idea that the difference between successive zero-crossing dz(i) is an integer multiple of F

dz(i)=k(i)F,

where k(i) is an integer.

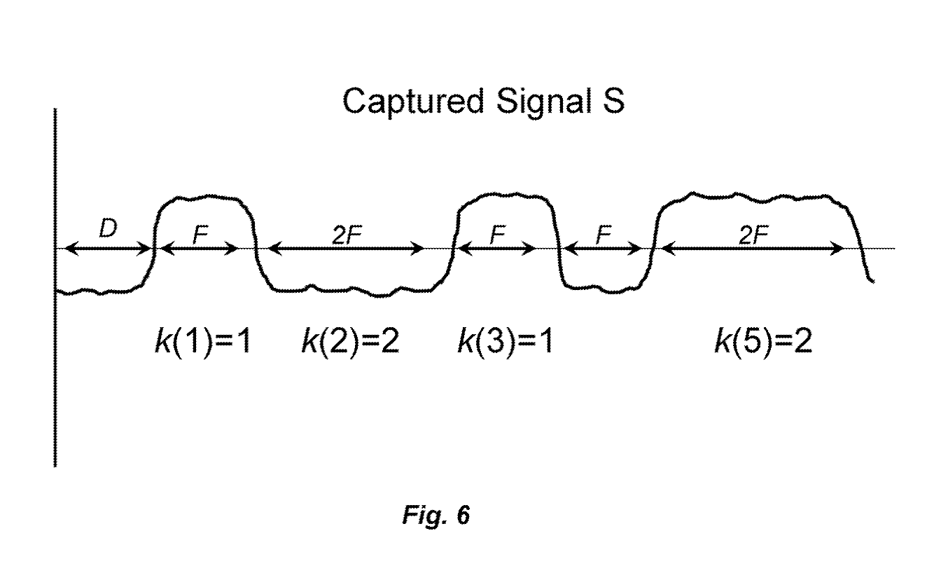

For the relative scale, k(i) is always one, because each zero-crossing occurs after every F pixels. However, for the absolute scale, the value of k(i) depends on the non-periodic sequence, and changes with every position of the readhead as shown in FIG. 6. The number of bits between every two zero-crossings is represented by k(i).

To perform the joint refinement of D, F and m, k(i) are determined using the coarse value of F and zero-crossings

$$k ( i ) = \frac{dz ( i )}{F} .$$

A linear system is formed to refine D, F and m. Ideally, each zero-crossing is an integer multiple of F away from the first zero-crossing D.

Each zero-crossing can be written in terms of D, F and m as

$$z ( i ) = D + F ( {\sum }_{j = 1}^{i - 1} k ( j ) ) .$$

With

$$c ( i ) = {\sum }_{j = 1}^{i - 1} k ( j ) ,$$

the number of bits between the i^{th} and the first zero-crossing is c(i). Thus, the i^{th} zero-crossing is c(i) times F from the first zero-crossing

z(i)=D+Fc(i).

Writing z(i) in terms of a(i) and b(i), we obtain

a(i)m+b(i)=D+Fc(i), and

D+Fc(i)−a(i)m=b(i).

Writing the above equation for all K zero-crossings, we can obtain a K by a three linear system

$$[ \begin{matrix}1 & c ( 1 ) & - a ( 1 ) \\ 1 & c ( 2 ) & - a ( 2 ) \\ 1 & c ( 3 ) & - a ( 3 ) \\ ⋮ & ⋮ & ⋮ \\ 1 & c ( K ) & - a ( K )\end{matrix} ] [ \begin{matrix}D \\ F \\ m\end{matrix} ] = [ \begin{matrix}b ( 1 ) \\ b ( 2 ) \\ b ( 3 ) \\ ⋮ \\ b ( K )\end{matrix} ] .$$

Solving the linear system provides the refined values of D, F and m. The linear system can be solved using conventional techniques.

Using the refined values of D and F, the incremental position Pᵢ can be determined. The sequence k(i) provides the underlying code in the current signal, and can be used to determine the absolute position P_{A} using the look-up table of the non-periodic sequence. The final position P is P_{A}+Pᵢ.

Variations

The method can iterate over the steps of zero-crossing detection, and solve the linear system. The refined m can re-determine the zero-crossings, the slopes a(i), and intercepts b(i) of the fitted lines followed by the refinement of D, F and m, and so on.

Instead of initializing in as the average value of the signal S, m can be determined by averaging high intensity pixels and low intensity pixels separately, followed by taking their averages. Any other way of determining m using the signal S is within the scope of the invention.

Other edge detection methods, such as the Sobel operator, Canny operator or any other edge detection method can be used to determine the zero-crossings of the signal, without the need for determining m. The determined zero-crossings can be used to refine D and F by solving a K by two linear system

$$[ \begin{matrix}1 & c ( 1 ) \\ 1 & c ( 2 ) \\ 1 & c ( 3 ) \\ ⋮ & ⋮ \\ 1 & c ( K )\end{matrix} ] [ \begin{matrix}D \\ F\end{matrix} ] = [ \begin{matrix}z ( 1 ) \\ z ( 2 ) \\ z ( 3 ) \\ ⋮ \\ z ( K )\end{matrix} ]$$

In this case, only D and F are refined.

While the above embodiment describes refining D, F and m to higher resolutions, another embodiment fixes m at the initial value, and only refines D and F. In this case, the zero-crossings z(i) are determined using the initial value of m as a(i)m+b(i). The refinement of D, F requires solving a K by 2 linear system, as described above. This is useful when the initial value of m is sufficient, or fewer computations are desired.

In the above embodiments, the phase is defined with respect to the first zero-crossing: However, the phase can be defined with respect to any zero-crossing. In particular, the zero-crossing nearest the center of the signal can be used to describe the phase and to solve the linear system. In general, the zero-crossing used to define phase could change with the each new position.

In some cases, the plane of the scale can be rotated with respect to the readhead. In such cases, the signal sensed from the scale can have a uniform or non-uniform scaling factor from one end of the sensor to the other end. This scaling factor can be incorporated into the above method by appropriately compensating the determined zero-crossings.

Optical distortions, such as radial distortion due to the lens, cause shifting of the zero-crossings. Such distortions can be handled by a calibration step, where the estimated zero-crossings are appropriately shifted before solving the linear system to compensate for the radial distortion.

Optical distortions can also be handled by augmenting the linear system to have additional parameters. For example, the equation can be augmented to have terms dependent on square of c(i)

a(i)m+b(i)=D+Fc(i)+α₁c(i)²+α₂c(i)³.

Using this equation, a linear system with five variables (m, D, F, α₁ and α₂) can be constructed. The parameters α₁ and α₂ model the deviation of zero-crossings from the original linear model and can handle optical distortions in the captured image. Additional parameters depend on powers of c(i) or a(i) can be added depending on the specific application.

Thermal expansion of the scale leads to a change in pixel per-half pitch F. A varying expansion across the field of view shifts the zero-crossings according to the expansion coefficient. The shift in zero-crossings can be determined during calibration. During run-time, zero-crossings can be appropriately shifted for compensation, before solving the linear system.

It should be understood that other practical sensing issues can be handled by appropriate modification of the above method, and are within the scope of the invention. For example, other non-linearities in the signal can lead to shift in zero-crossings, and can be appropriately compensated.

Embodiments of the invention also apply to a relative scale to obtain the incremental position Pᵢ. In case of relative encoders, the method can be used to obtain Pᵢ and the coarse position P_{A} can be obtained using other known methods, such as using a second scale.

The invention is also applicable to single-track rotary encoders. If the non-periodic de Bruijn sequence is used, then other configurations of the scale can be used, for example, a circular, serpentine, or other arbitrary shapes that conform to the positions to be determined.

### Effect of the Invention

Prior art methods are typically based on demodulation techniques, and require a reference sine and cosine signal for demodulation in relative encoders, or a reference waveform depending on an underlying code for absolute encoder as in the related application. This invention does not require generating such a reference signal.

Some prior art methods use a two step process. In the first step, the fundamental frequency is estimated. In the second step, the reference signals are generated using the fundamental frequency. The reference signals are used for demodulation or position decoding. However, the errors in the first step lead to frequency mismatch between the sensed signal and the reference signal. This can lead to significant phase errors.

This invention does not require reference signals. In addition, the fundamental frequency and phase are estimated jointly, thus significantly reducing the phase errors.

The invention works independently of the gain of the sensed signal and can recover the position estimate without the knowledge of the gain of the sensed signal.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for determining a position, comprising the steps of:
sensing a signal corresponding to a subsequence of marks in a non-periodic sequence of the marks on a scale;
determining a coarse position P_{A} by matching the subsequence with all possible subsequences of the non-periodic sequence;
detecting zero-crossings corresponding to rising edges of the signal and zero-crossings corresponding to falling edges of the signal
computing an incremental position Pᵢ using detected zero-crossings; and
summing the coarse and incremental position to obtain the position, wherein the steps are performed in a digital signal processor.

2. The method of claim 1, wherein the coarse position is at a distance D from a selected reference zero-crossing, and the incremental position Pᵢ is D/F, where F is a frequency of the half pitch.

3. The method of claim 1, wherein a width B of each mark is a half-pitch.

4. The method of claim 1, wherein the signal is sensed by a readhead including a complementary metal-oxide-semiconductor (CMOS) or charge coupled device with an array of pixels.

5. The method of claim 1, wherein the non-periodic sequence is a de Bruijn sequence.

6. The method of claim 1, wherein the marks are arranged sequentially and linearly.

7. The method of claim 1, wherein the marks are arranged sequentially in an arbitrary configuration.

8. The method of claim 3, wherein a resolution of the position is substantially higher that the half pitch.

9. The method of claim 8, wherein an accuracy of the position is substantially higher that the half pitch.

10. The method of claim 3, wherein a frequency of the half pitch is F.

11. The method of claim 1, wherein the coarse position is at a distance P_{A} from a start of the scale, a width B of each mark is a half-pitch, and a frequency of the half pitch is F, and the incremental position is Pᵢ is
$$\frac{DB}{F}$$

12. The method of claim 1, wherein the zero-crossings are with respect to a threshold m.

13. The method of claim 13, wherein the threshold is fixed.

14. The method of claim 13, wherein the threshold is refined along with phase and frequency of the signal.

15. The method of claim 12, wherein an initial value of m is estimated from the signal S as an average intensity of the signal S
$$m = \frac{{\sum }_{p = 1}^{N} S ( p )}{N} ,$$
where p is a number of samples N of the signal S.

16. The method of claim 12, wherein the detecting fits lines to each rising edge and the falling edge, wherein each line has a slope aₚ and intercept bₚ.

17. The method of claim 16, wherein the slope and intercept are
$$a = \frac{1}{S ( p + 1 ) - S ( p )} , b = p - \frac{S ( p )}{S ( p + 1 ) - S ( p )} ,$$
respectively, and a spatial location corresponding to the intensity of m on the line is
z=a×m+b.

18. The method of claim 16 in which slope aₚ and intercept bₚ are identical for all rising edges, and the slope −aₚ is shared by all falling edges.

19. The method of claim 17, wherein a resolution of z is substantially higher than a pixel resolution of the sensor.

20. The method of claim 11, wherein the zero-crossings are with respect to a threshold m, and D, F and in are refined using a linear system.

21. An apparatus for determining a position, comprising:
a readhead configured to sense a signal corresponding to a subsequence of marks in a non-periodic sequence of the marks on a scale; and
a digital signal processor (DSP) configured to determine a coarse position P_{A} by matching the subsequence with all possible subsequences of the non-periodic sequence, and to detect zero-crossings corresponding to rising edges of the signal and zero-crossings corresponding to falling edges of the signal, and the DSP computes an incremental position Pᵢ using the zero-crossings, and wherein a sum of the coarse and incremental positions is the position.
